(19) United States
(12) Patent Application Publication
(10) Pub. No.: US 2017/0089417 A1
(43) Pub. Date: Mar. 30, 2017

(54) Damper Assembly for Providing Different Damping Effects at Different Parts of the Stroke

(71) Applicant: Lama D. D. Dekani, Dekani (SI)

(72) Inventors: David Pecar, Pobegi (SI); Valter Svara, Izola (SI)

(21) Appl. No.: 15/315,741

(22) PCT Filed: May 29, 2015
(86) PCT No.: PCT/EP2015/062029

§ 371 Date: Dec. 2, 2016

(30) Foreign Application Priority Data
Jun. 3, 2014 (GB) 1409874.3

(51) Int. Cl. F16F 9/32; F16F 9/36; F16F 9/10

(52) U.S. Cl. CPC F16F 9/3214; F16F 9/10; F16F 9/368; F16F 2222/12

(57) ABSTRACT

A damper assembly comprises a piston and cylinder type damper with a piston assembly (10) mounted for reciprocal movement in a cylinder (12) containing damping fluid. The piston assembly divides the interior of the cylinder into two chambers and provides a means of communication in the form of channels (12a, 12b, 17, 20) for passage of damping fluid between the chambers. The channels are arranged to allow passage of more or less damping fluid, depending on the position of the piston assembly with respect to the cylinder along its path of reciprocation.

This invention relates to dampers.

The invention provides a damper assembly comprising a piston and cylinder type damper with a piston assembly mounted for reciprocal movement in a cylinder containing damping fluid, with the piston assembly dividing the interior of the cylinder into two chambers and providing a means of communication for passage of damping fluid between the chambers, wherein the means of communication is arranged to allow passage of more or less damping fluid depending on the position of the piston assembly with respect to the cylinder along its path of reciprocation.

By way of example, embodiments of the invention will now be described with reference to the accompanying drawings, in which:

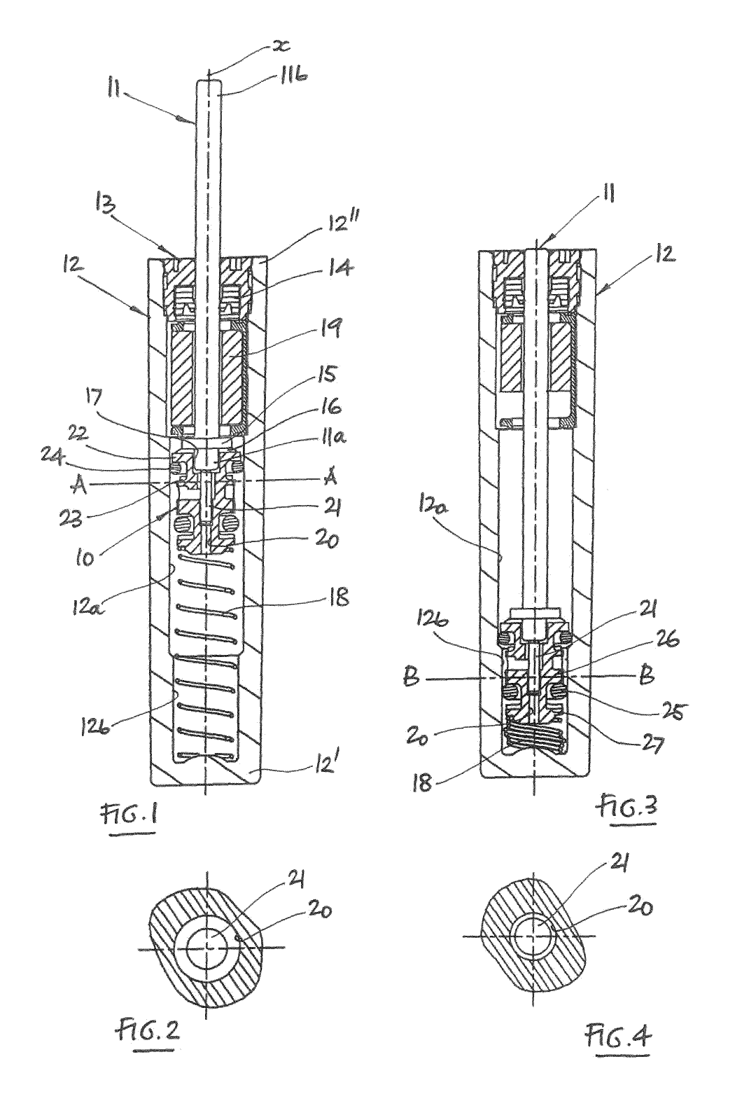

FIG. 1 is a sectional view through a damper according to the invention in its fully extended condition,

FIG. 2 is a part cross-sectional view through the piston assembly of the FIG. 1 damper in the plane marked AA,

FIG. 3 is a sectional view through the FIG. 1 damper in its fully compressed condition, and

FIG. 4 is a part cross-sectional view through the piston assembly in the plane marked BB.

The damper seen in FIG. 1 is a linear piston and cylinder type damper having a piston assembly 10, a piston rod 11 and a cylinder 12. The cylinder 12 is closed at one end 12′ and contains a damping medium, such as oil or silicone. The piston rod 11 is mounted for linear reciprocal movement with respect to the cylinder 12 along its longitudinal axis x. A free end of the piston rod 11 extends out of the other end 12″ of the cylinder 12, which is open. A cap assembly 13 closes off the open end 12″ of the cylinder 12. The cap assembly 13 provides sliding support for the mounting of the piston rod 11 and has a suitable seal 14 to prevent leakage of damping medium out of the cylinder 12.

The piston rod 11 extends into the interior of the cylinder 12, where its inner end 11a engages the piston assembly 10. More particularly, the piston rod 11 incorporates a flange 15 which engages an axial end surface of the piston assembly 10. The arrangement helps to spread the load and thus minimise the risk of damage to the piston assembly 10, which may typically be made out of plastics material. A groove 16 is provided in the axial end surface of the piston assembly 10 to allow for passage of damping medium between the flange 15 and the piston assembly.

A hole 17 in the axial end surface of the piston assembly 10 is designed to receive the inner end 11a of the piston rod 11 to help position and guide it during its movement relative to the cylinder 12. Space is provided between the piston rod inner end 11a and the hole 17 to allow for passage of damping medium.

The piston assembly 10 divides the interior of the cylinder 12 into two separate chambers. A compression spring 18 is arranged in one of these chambers, mounted between the closed end 12′ of the cylinder 12 and the piston assembly 10. The spring 18 acts to press the piston assembly 10 into its engagement with the piston rod 11, hence biasing the piston rod towards its extended position. In the other chamber, a resiliently collapsible element 19 of known design is arranged. The purpose of this element 19 is to compensate for changes in volume in the chambers within the cylinder 12 that result from movements of the piston assembly 10.

The damper is seen in FIG. 1 in its fully extended condition, that is, with the free end 11b of the piston rod 11 extending out of the cylinder 12 to its fullest extent. In FIG. 3, the damper is seen in its fully compressed condition, that is, with the piston rod 11 pressed into the cylinder 12 to its fullest extent. The difference between these two extremes, going from the FIG. 1 condition to the FIG. 3 condition, represents the working stroke of the damper. In its working stroke, the damper provides a damped resistive force to an impact on the free end 11b of the piston rod 11, for example, from a closing door. On its return stroke, that is, going from the FIG. 3 condition back to the FIG. 1 condition, the damper provides little or no damped resistive force. The return stroke of the damper is effected by the action of the spring 18.

It will be seen that the bore of the cylinder 12 is stepped, meaning that the piston assembly 10 will travel through bores of different diameters during its working stroke. This arrangement enables the damper to be designed to produce damped resistive forces of different magnitudes in two distinct stages. The first of these stages occurs when the piston rod 11 is initially pressed into the cylinder 12 from its fully extended position. In this initial stage, it is preferable for the resistive force produced by the damper to be relatively “soft”, ie of relatively low magnitude. If the initial action of the damper is too hard, there can be a tendency for it not to absorb energy, but simply to reflect it. In practice this is manifested by a closing door tending to bounce off the damper. In the second stage, the resistive force can be designed to be much greater. In this way, the damper can be tailored to be capable of absorbing relatively high impacts without causing “bounce”.

The action of the damper is governed by a number of controllable passageways in the piston assembly 10 that allow for various different predetermined flows of damping medium between the two chambers. Fluid communication between the two chambers during the working stroke of the damper is provided principally by a central conduit 20 that extends through the piston assembly 10. The conduit 20 is stepped and has located within it an elongate pin element 21. The pin element 21 is designed to partly occlude the conduit 20, thereby leaving gaps between them which vary in size along the length of the pin element. It is these gaps that essentially control the damping characteristics of the damper, as will be explained in more detail below.

As its end near the piston rod 11, the piston assembly 10 has axially spaced apart flanges 22, 23 and between these is located a first seal 24 in the form of an O-ring. The seal 24 is in sealing engagement with the larger bore portion 12a of the cylinder 12 and is able to move axially relative to the piston assembly 10 between the flanges 22, 23. When the piston rod 11 receives an impact, eg from a closing door, it will drive the piston assembly 10 further into the cylinder 12 and as it does so, the flange 22 will be pressed into abutting engagement with the seal 23, thus effectively sealing off fluid communication around the outside of the flange 22. In this state, fluid communication across the piston assembly 10 is only possible via the annular gap between the pin element 21 and the conduit 20 at the position marked AA in FIG. 1. As seen in FIG. 2, this annular gap is relatively large, meaning that the damping action at this stage is of relatively low magnitude.

If the piston rod 11 continues to be forced into the cylinder 12, it will continue to drive the piston assembly 10 further into the cylinder until it will eventually enter into the smaller bore portion 12b of the cylinder 12. The smaller bore portion 12b is designed to be sealingly engaged by a second seal 25 on the piston assembly 10, also in the form of an O-ring. The second seal 25 is located between two further flanges 26, 27 spaced axially apart on the piston assembly 10 and is moveable axially relative to the piston assembly between these flanges.

As the piston assembly 10 continues to be pressed further into the cylinder 12, it will eventually enter into the smaller bore portion 12b. At this stage, the second seal 25 will come into sealing engagement with the smaller bore portion 12b. The second seal 25 at this time will also be in abutting engagement with the flange 26, thus effectively sealing off fluid communication around the outside of this flange. Now, the only fluid communication across the piston assembly 10 is via the annular gap between the pin element 21 and the conduit 20 at the position marked BB in FIG. 3. As will be seen in FIG. 4, this annular gap is relatively small, meaning that the damping action at this stage will be of relatively high magnitude.

In practice, dampers of this nature for use in furniture are relatively small items, and the passageways that provide the controlled flow of fluid across the piston assembly are consequently tiny. The arrangements described above of providing a conduit which is partly occluded by a control element have the advantage that they enable the damping characteristics of the damper to be controllable with a fair degree of accuracy and with a fair degree of reliability in terms of manufacturing tolerance.

It will be understood that the damper can be designed to have more than the two stages of damping illustrated in this embodiment.

It will further be understood that the mechanism for providing different damping characteristics, ie the controllable fluid passageways of predetermined dimensions, here in the form of a pin element in a stepped conduit, may be varied. For example, one possible alternative arrangement would be to provide a plain conduit through the piston assembly with a stepped diameter pin element. Another alternative would be to replace the pin element with another form of element, such as a sphere, or provide two or more such elements.

1. A damper assembly comprising a piston and cylinder type damper with a piston assembly mounted for reciprocal movement in a cylinder containing damping fluid, with the piston assembly dividing the interior of the cylinder into two chambers and providing a means of communication for passage of damping fluid between the chambers, wherein the means of communication is arranged to allow passage of more or less damping fluid depending on the position of the piston assembly with respect to the cylinder along its path of reciprocation.

2. A damper assembly as claimed in claim 1 wherein the means of communication includes a conduit through the piston assembly.

3. A damper assembly as claimed in claim 2 wherein the conduit contains an element that partly occludes it.

4. A damper assembly as claimed in claim 3 wherein the element is in the form of an elongate pin.

5. A damper assembly as claimed in claim 2 wherein the conduit has a stepped bore.

6. A damper assembly as claimed in claim 1 wherein the cylinder has a stepped bore.

7. A damper assembly as claimed in claim 1 wherein the piston assembly comprises a seal for sealingly engaging the or each different diameter bore portion of the cylinder.

8. A damper assembly as claimed in claim 7 wherein the cylinder has at least two different diameter bore portions and the piston assembly has at least two seals, a respective one to suit each bore portion.

9. A damper assembly as claimed in claim 1 wherein the means of communication is arranged to allow passage of less damping fluid towards the end of the working stroke of the piston assembly.
